(19) United States
(12) Patent Application Publication
(10) Pub. No.: US 2003/0027594 A1
(43) Pub. Date: Feb. 6, 2003

(54) Method for presetting a mobile phone communications mode and vehicle mobile phone arrangement

(76) Inventor: Thomas Pfoertner, Hoehenkirchen (DE)

Correspondence Address: Morrison & Foerster LLP, Suite 300, 1650 Tysons Boulevard, McLean, VA, 22102, US

(21) Appl. No.: 10/193,679

(22) Filed: Jul. 12, 2002

(30) Foreign Application Priority Data
Jul. 13, 2001 (DE) 10134098.9

(51) Int. Cl. H04B 1/38

(52) U.S. Cl. 455/557; 455/99

(57) ABSTRACT

Method for presetting a mobile phone communications mode in a vehicle, in particular a motor vehicle, using at least one built-in mobile phone terminal or a built-in holder and a portable mobile phone terminal which fits in the latter, at least one communications function of the mobile phone terminal, or of at least one mobile phone terminal, being automatically controlled by a function of the vehicle or of a peripheral unit thereof and/or at least one separate data carrier, in particular a chip card or magnetic card, in such a way that various communications profiles are thus set.

### CLAIM FOR PRIORITY

This application claims priority from German application number 10134098.2 filed Jul. 13, 2001.

### TECHNICAL FIELD OF THE INVENTION

The invention relates to a method for presetting a mobile phone communications mode in a vehicle, and to a vehicle mobile phone arrangement.

### BACKGROUND OF THE INVENTION

In developed countries, mobile phone terminals have become as indispensable, as communication instruments, to people's daily business and personal lives as individual road transport, in particular with passenger cars. The desire to be accessible at any place and at any time via communications links induces large numbers of users of mobile telephones to use their mobile telephone also in their cars, even in dense traffic. As in many other countries, legislators in Germany have recently also prohibited “hands-free” use of mobile telephones in cars because their use had become a serious risk in road traffic.

For a number of years motor vehicle manufacturers have offered integrated mobile phone terminals which have been linked in some cases to the car radio and/or an on-board computer and/or to a navigation system to form complex data and communications systems. At the same time, so that users can also use the mobile phone which they normally use outside a car, built-in holders are offered which both provide the recently prescribed hands-free functions as well as also permit power-supply and recharging functions, and also frequently provides a connection to an external antenna.

Despite these developments which significantly simplify the use of mobile phone facilities in road traffic, there a still considerable insufficiencies. Both the operation of a conventional mobile phone and also the reading of its display are made much more difficult in built-in holder and virtually impossible for persons with restricted vision while driving. Permanently installed mobile phones and complex data/telecommunications systems are, on the one hand, extremely expensive and, on the other hand, their use is frequently not sufficiently attractive for those interested, often owing to the lack of adaptation to the specific conditions of use of a motor vehicle and insufficient possibilities of co-ordination with the operation of the “normal” mobile phone.

### SUMMARY OF THE INVENTION

One embodiment of the invention discloses an improved method and vehicle mobile phone arrangement of the generic type which provides the user with significantly better possibilities of use with an acceptable degree of expenditure, while in particular also road safety is to be increased through ease of handling.

The invention includes, for example, activating adapted mobile phone communications profiles in a vehicle on the basis of the registration of specific vehicle functions or function parameters and, alternative or additionally, by using a suitable data carrier, in particular a magnetic card or chip card. In this way, an embodiment of mobile communication which is suitable for road traffic is defined without communications conditions or parameters being set by the driver in a qualified and conscious way (which is associated with some degree of expenditure).

As a function of the “intelligence” (of conventional door locks and ignition locks, speedometers and revolution counters and the computerized access control and function monitoring systems) which are specifically presenting the vehicle in question, it is possible to implement a wide range of ways of influencing these functions of mobile phone terminals used in the vehicle in order to facilitate handling and increase road safety with respect to facilities ranging from relatively simple built-in holders to complex, permanently installed communications systems.

In one preferred embodiment which is suitable in particular for new vehicles with keyless-go and keyless-entry systems, but can also be retrofitted in vehicles without such systems, one or more basic communications profiles are predefined by a data record which is stored on a data carrier (magnetic card or chip card). Before and during the activation of the vehicle, the data record is read by means of a suitable reading device which is present in any case in vehicles with keyless-go and keyless-entry systems.

Moreover, the data record can also be stored in an SCP of the mobile phone and can then be accessed there via an identifier stored in the data carrier.

The data record brings about the setting of communications profile which allows for both traffic-related as well as specific user requirements. In this way, it is possible, for example, for various drivers of the same vehicle to predefine in each case their specific basic communications profile, for example with respect to call diversion functions. Accordingly, the proposed vehicle mobile phone arrangement is configured for operation with one or a plurality of magnetic cards or chip cards, which are each assigned to a user of the system or programmed for specific application situations.

Further settings or modifications of the basic communications profile are then performed automatically as a function of specific driving states or driving operation parameters and/or operating states of peripheral units (car radio, traffic information system or navigation system etc.). These settings or modifications are then preferably user-nonspecific and are tailored to basic principles of operational reliability and traffic safety.

However, it is also possible to implement specific basic settings, for example by means of switching contacts of a built-in holder or by means of specifically preprogrammed settings of a built-in mobile phone. Additional operating switches also permit user-specific pre-settings here, which pre-settings can then in turn be modified as a result of the registration of vehicle functions or vehicle function parameters.

In a one preferred application, a communications profile can be set to include a voice control mode and/or a text-message voice output mode. The latter can already be preprogrammed on the data carrier or be temporarily set in accordance with a vehicle function or driving state. It is thus possible, for example, to operate, by using a voice recognition device or synthesizer which is permanently installed in the vehicle (and belongs for example to an on-board computer system), a mobile phone which is permanently installed or plugged into the built-in holder with an advanced, convenient voice control facility without the drive having to remove his hands from the steering wheel to perform difficult key entries or distract his attention from the events on the road. At the same time, text messages (SMS messages or messages transmitted by WAP) received by the mobile phone can be output as voice messages. This avoids the need for the user to have to decipher the message on the small mobile phone display which is difficult to read. (Voice recognition devices and/or synthesizers can also be implemented in the IP of the mobile phone network).

In a further embodiment, in one communications profile which can be set a specific call diversion function is implemented—in particular when the velocity of the vehicle is high and/or the internal sound volume is high or during the voice output of a traffic information system or navigation system. Incoming calls in such phases are diverted in particular to a voice mailbox. The call diversion can be implemented in particular in a fashion which is differentiated on the basis of what is referred to as a black/white list of predetermined call numbers which is stored, if appropriate, in the SCP of the mobile phone network. Other data for implementing the communications profiles can also be stored there.

In another embodiment, one of the communications profiles which can be set already includes the automatic activation of a built-in mobile phone terminal, in particular when the vehicle is entered or started or when the data carrier is read. In vehicles with keyless-entry or keyless-go equipment, these operations coincide if, which is of course expedient here, the chip card with the authorization data for use of the vehicle includes at the same time the data carrier for setting the communications profile or for an identifier for calling it from the network.

The activation of the built-in mobile phone terminal is preferably associated with automatic deactivation of further (portable) mobile phones which may possibly be located in the vehicle. This excludes the possibility of the further mobile phones giving rise to disruption or destruction while the driver is driving. It is also preferred, in this context, to establish a call diversion to the built-in mobile phone terminal, which call diversion may, in particular, already be programmed on the data carrier or else in the built-in mobile phone itself or stored in the mobile phone network.

The device aspects of a mobile phone arrangement in a vehicle also correspond to the method aspects mentioned above, and a person skilled in the art should readily be able to derive such device aspects from the aforesaid method aspects. For this reason, only few components of such a system are referred to here, insofar as device aspects have not already also been mentioned above.

A data carrier reading device and/or a function sensor for registering a vehicle function or an equipment function of a peripheral unit in the vehicle are components of the proposed system. A communications mode control unit for controlling the aforesaid communications modes is connected to the reading device or to the function sensor. The communications mode control unit can in turn be connected to a built-in voice recognition device and/or voice synthesizer and/or a call diversion control unit. In addition, it can be embodied as a switching unit for enabling or activating a built-in mobile phone terminal, in particular with simultaneously disabling or deactivation of a conventional mobile phone which is located in the vehicle.

### BRIEF DESCRIPTION OF THE DRAWINGS

Advantages of the invention also emerge from the following description of exemplary embodiments and embodiment aspects of the invention with reference to the figures, of which:

FIG. 1 shows a basic sketch explaining the invention.

FIG. 2 shows a functional block circuit diagram of a mobile phone arrangement in a vehicle according to a preferred embodiment of the invention.

### DETAILED DESCRIPTION OF THE INVENTION

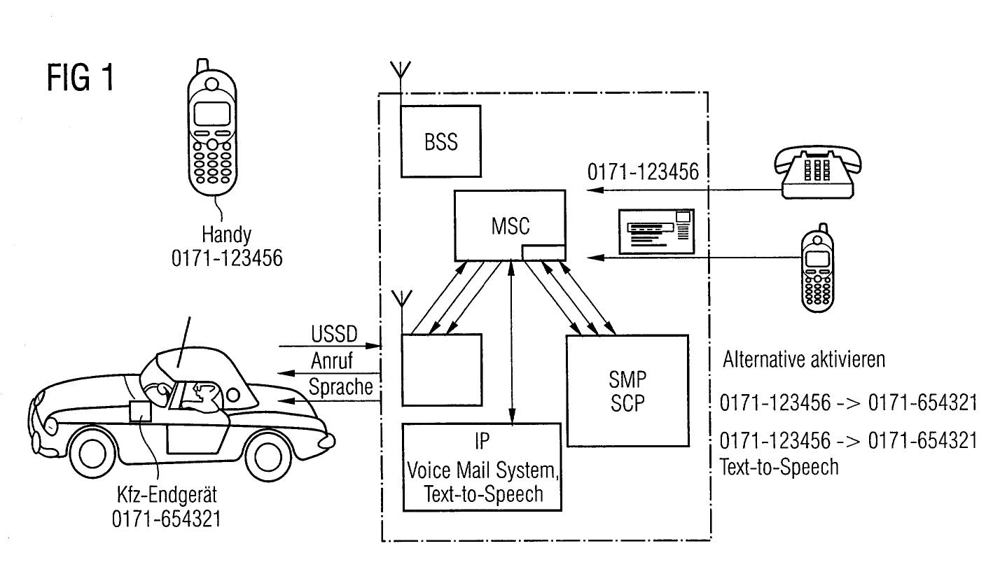

FIG. 1 is an exemplary embodiment of the present invention. The driver of the convertible illustrated alternatively has a conventional (portable) mobile phone with the call number 0171-123456, and a built-in motor vehicle terminal with the call number 0171-654321. In the top right part of the figure it is shown that normal calls (voice messages) and text messages can be received on the call number 0171-123456 of the conventional mobile phone while the user is seated in the convertible.

However, the user has activated his motor vehicle terminal with the number 0171-654321 (for example by inserting the magnetic card or chip card mentioned above) and at the same time deactivating the mobile phone, which has been signaled to the mobile phone operator via USSD. The respective message was transmitted to the service administration/service control node SMP SCP via the base station BSS which is being used at the particular time and the mobile switching center MSC, at which service administration/service control node SMP SCP the call diversion from the mobile phone to the motor vehicle terminal is registered and implemented and the necessary data stored.

The arrow “voice” on the left-hand side of the figure and the indication of the “text-to-speech” bottom right symbolize that at the same time text messages (for example SMS) are converted into voice messages and offered to the user as such via the hands-free device of his motor vehicle terminal. An intelligent peripheral IP implements both this function and a call diversion to a voice mailbox when there are specific driving states in which according to the communications profile which is set the driver does not wish to receive any calls.

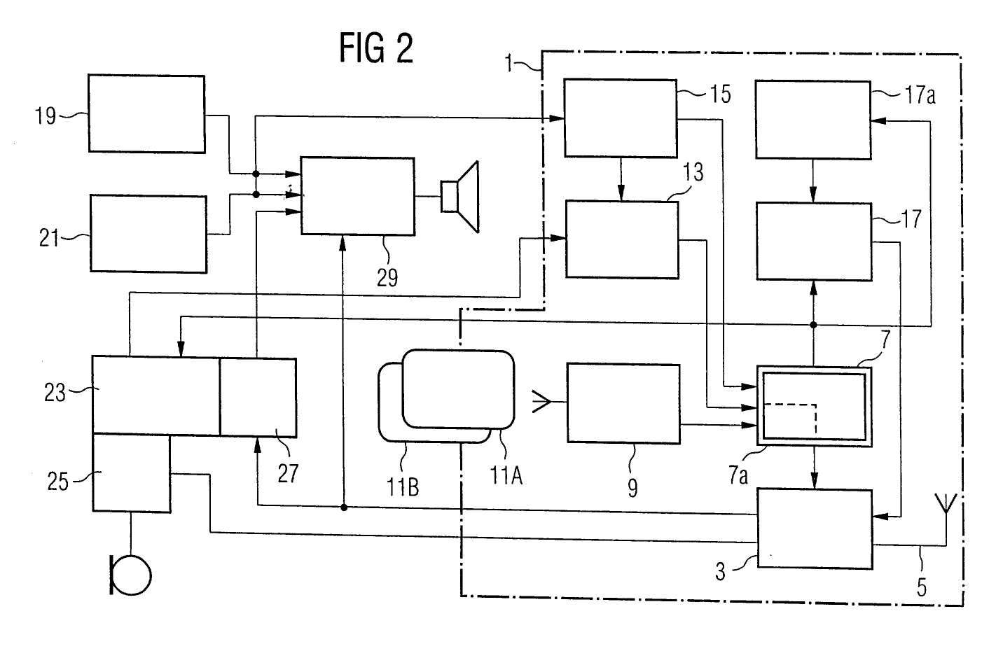

FIG. 2 illustrates in a rough schematic fashion (ignoring the actual division of functions between vehicle-internal or terminal-internal units and external system components of the mobile phone system) the functional components of a mobile phone arrangement 1 in a vehicle which are essential in relation to the execution of the invention.

The mobile phone arrangement 1 in a vehicle is permanently installed in mobile phone terminal 3 which is permanently connected to a vehicle mobile phone antenna 5 and the on-board power supply (not illustrated). The built-in mobile phone terminal 3 is assigned a communications mode control unit 7 whose design corresponds essentially to that of a computer and which has, inter alia, a main memory 7a in which in each case an active communications profile is stored.

The communications mode control unit 7 is connected at the input end to a card reader 9 which operates in a contactless fashion for reading chip cards 11A, 11B—which is at the same time a component of a keyless-entry/keyless-go system—and to a vehicle function registering unit 13 and a traffic information registering unit 15. At the output end, the communications mode control unit 7 is connected not only to the terminal 3 but also to a call diversion control unit 17 to which a call diversion list store 17a is assigned. The latter is also connected at the input end to the communications mode control unit 7 for user-specific setting of black/white lists for the call diversion.

The mobile phone arrangement 1 in a vehicle interacts with a navigation system 19, a car radio 21 with a traffic radio decoder and an on-board computer 23 to which a voice recognition device 25 and a voice synthesizer stage 27 are assigned. The navigation system 19, the car radio 21 and the voice synthesizer stage 27 are connected to inputs of an audio unit 29. As is apparent from the figure, the mobile phone terminal 3 is (optionally) connected at the input end to the voice recognition device 25 and at the output end both directly to the audio stage 29 and to the voice synthesizer stage 27.

The function of this arrangement is largely clear from the above statements and will therefore be outlined only briefly here: depending on the specific embodiment of the vehicle access and actuation system, the chip card 11A or 11B is already read via the card reader 9 when the car doors are opened or the vehicle activated, and a mobile phone communications profile is read into the main memory 7a of the communications mode control unit 7 in accordance with the data programmed onto the chip card 11A or 11B. The communications mode control unit 7 activates the built-in mobile phone terminal 3 and, by emitting a corresponding message to the mobile phone operator, brings about deactivation of a further mobile phone which may, under certain circumstances, be located in the car, via the mobile phone terminal 3.

Depending on the communications profile stored, a speech control mode is activated by means of the voice recognition device 25 and the speech output of incoming text messages via the speech synthesizer stage 27, either continuously or temporarily in certain operating states of the navigation system 19 or car radio 21 or when specific output signals of the on-board computer 23 are applied. Furthermore, depending on the presence of audio signals of the navigation system 19 or of the traffic radio decoder in the car radio 21 at the input of the audio unit 29, the call diversion control unit 17 is activated in order to divert calls from less important call numbers which are received at the mobile phone terminal 3 at corresponding times. Calls from prioritized call numbers are, on the other hand, indicated to the driver audibly and/or visually so that he can, if appropriate, interrupt the ongoing announcement of the navigation system 19 or traffic radio announcement of the car radio 21 and accept the call.

The embodiment of the invention is not restricted to the general configuration outlined above or to the specific exemplary embodiment described above but rather is also possible in a multiplicity of refinements which lie within the scope of the activity of a person skilled in the art.

What is claimed is:

1. A method for presetting a mobile phone communications mode in a vehicle using at least one built in mobile phone terminal or a built-in holder and a portable mobile phone terminal which fits into the built-in terminal or holder, comprising:
automatically controlling at least one communications function of the mobile phone terminal by a function of the vehicle or of a peripheral unit thereof and/or at least one separate data carrier such that various communications profiles are set.

2. The method as claimed in claim 1, wherein at least one basic communications profile which is stored on the at least one data carrier and/or implemented at least partially in a service control node of a mobile phone network is temporarily modified with at least one basic setting of the mobile phone terminal in response to registration of vehicle functions or function parameters.

3. The method as claimed in claim 1, wherein an adjustable communications profile includes a voice control mode and/or text-message voice output mode.

4. The method as claimed in claim 3, wherein the voice control or voice output mode is carried out with access to a voice recognition device or voice synthesizer which is installed in the vehicle or implemented in an intelligent peripheral of a mobile phone network.

5. The method as claimed in claim 1, wherein an adjustable communications profile includes a call divert function which can be controlled as a function of a velocity of the vehicle and/or internal sound volume and/or caller number and/or a function of a traffic information system or navigation system.

6. The method as claimed in claim 5, wherein the call divert function includes a call diversion to a voice mailbox.

7. The method as claimed in claim 1, wherein an adjustable communications profile includes the automatic activation of a built-in mobile phone terminal when the vehicle is entered or started or when the data carrier is read.

8. The method as claimed in claim 7, wherein the activation of the built-in mobile phone terminal is associated with an automatic deactivation of a portable mobile phone terminal which is located in the vehicle.

9. The method as claimed in claim 1, wherein a chip card which is read in a contactless fashion and is used as data carrier for controlling the vehicle functions.

10. The vehicle mobile phone arrangement, comprising:
a mobile phone terminal which is installed in a vehicle, or a built-in holder for receiving a portable mobile phone terminal;
a card reading device, assigned to the installed mobile phone terminal and/or the built-in holder for reading a data carrier;
a function sensor for registering a vehicle function or an equipment function of a peripheral unit; and
a communications mode control unit, connected to the card reading device and/or the function sensor at the input end, for controlling at least one communications function of the mobile phone terminal, or of at least one mobile phone terminal, as a function of the information content of the data carrier and/or of a registration result of the function sensor.

11. The vehicle mobile phone arrangement as claimed in claim 10, further comprising a built-in voice recognition device and/or voice synthesizer or an interface to a voice recognition device or synthesizer which is implemented in a mobile phone network and which is connected via a control input to the communications mode control unit.

12. The vehicle mobile phone arrangement as claimed in claim 10, further comprising a call diversion control unit which is connected via a control input to the communications mode control unit for automatically activating/deactivating a call diversion.

13. The vehicle mobile phone arrangement as claimed in claim 12, wherein the call diversion control unit has a call number list store for storing a black/white list of call numbers for which a specific call diversion is valid, or an interface to a call number list store which is implemented in a service control node of a mobile phone network.

14. The vehicle mobile phone arrangement as claimed in claim 10, wherein the communications mode control unit controls, in response to the reading of a data carrier which authorizes the control, a keyless-go or keyless-entry system, activation of the built-in mobile phone terminal and at the same time deactivation of a portable mobile phone terminal located in the vehicle.

15. The vehicle mobile phone arrangement as claimed in claim 14, wherein the communications mode control unit is configured to automatically set a call diversion from the portable mobile phone terminal to the built-in mobile phone terminal.

16. The vehicle mobile phone arrangement as claimed in claim 10, wherein the function sensor is connected to a tachometer and/or revolution counter of the vehicle and/or to an audio output of a traffic information system or navigation system or a signal output of a vehicle-mounted computer.

17. The vehicle mobile phone arrangement as claimed in claim 10, wherein the reading device of an access control system or activation control system of the vehicle is used as card reading device.

18. The vehicle mobile radio arrangement as claimed in claim 10, defined by a multiplicity of exchangeable data carriers, in particular magnet cards or chip cards, for storing specific basic communications profiles of various users or for various application situations.
